(19) United States
(12) Patent Application Publication
(10) Pub. No.: US 2006/0192054 A1
(43) Pub. Date: Aug. 31, 2006

(54) Inflatable and deployable systems with three dimensionally reinforced membranes

(76) Inventor: Timothy T. Lachenmeier, Tillamook, OR (US)

Correspondence Address: HOLLAND & KNIGHT LLP, 2099 PENNSYLVANIA AVE, N.W., WASHINGTON, DC, 20006, US

(21) Appl. No.: 11/250,191

(22) Filed: Oct. 13, 2005

Related U.S. Application Data
(60) Provisional application No. 60/618,160, filed on Oct. 13, 2004.

(51) Int. Cl. B64D 17/02

(52) U.S. Cl. 244/145

(57) ABSTRACT

An illustrative embodiment of the invention includes an apparatus and method for making air and space inflatables and deployables using three dimensionally reinforced (3DR) membranes. A 3DR process preferably takes plural substantially flat gore segments, each segment made of plural membranes and reinforcing fibers, and joins adjacent gores so the seams on opposite sides are offset. Single ply seam tape may be used. When all gores are joined, a three dimensional deployable or inflatable (e.g., balloon) structure with a minimized seam is produced. Further, localized fiber reinforcement may be used, with different characteristics depending on the desired placement in the gore, allowing the substantially flat gores, when joined and loaded, to strain to the desired three dimensional shape. In doing so, the required number of gores and seams may be reduced, while using materials with significantly lower areal densities. Thus, the 3DR process allows one to make locally reinforced materials that optimize strength to weight ratios; permits single ply and sub-gore width seam tapes; permits multi-phase optimized envelope shapes, designed to efficiently handle multiple loading conditions; and provides increased design flexibility for a wide range of shapes and characteristics impractical or unavailable under prior techniques.

### RELATED APPLICATION

This application continues from U.S. Provisional Patent Application Ser. No. 60/618160, filed Oct. 13, 2004, of same title and inventors, which application is incorporated by reference herein for all purposes.

### GOVERNMENT INTEREST

The Government has certain interests in this invention pursuant to Contract Nos. NAS3-00080 and NAS3-01015 (NASA), and DG1330-02CN-0058 and 50-DKNA-1-90041 (NOAA).

### FIELD OF THE INVENTION

The invention in general relates to high performance and efficient membrane systems, and more particularly relates to three dimensionally reinforced inflatables/deployables made with plural shaped and joined membrane segments.

Three applications: Near space platform & vehicles (alt 65k to 150k) incl. high altit airship hulls and components such as fins, load patches & other local reinforcements; heavier than air craft (fuselage, wings, stabilizers & control surfaces); incorporating sensors and controls into “smart structures”.

### BACKGROUND

Terrestrial and space inflatables—like balloons—are traditionally constructed by joining a series of specially shaped flat gores to approximate the desired three-dimensional shape. With typical gore construction, the most severe localized load determines the materials'areal density. To improve the fidelity of the shape and the resultant localized loads, additional gores and seams may be added. However, additional seams increase the structural discontinuities, affecting reliability and significantly impacting weight and cost.

Although a wide variety of materials and sealing/joining equipment may be applied, almost all inflatable and deployable membrane fabrication methods involve joining specially shaped flat gores (i.e., shaped segments, typically roughly triangular-shaped) to form the desired three-dimensional shape. A hot wheel sealer is typically used to join polyester (Mylar) film gores in a heat-activated adhesive bi-taped seam. This type of seam construction has been used on thousands of polyester superpressure balloons, and bi-taped seams are considered generally reliable.

The gores themselves are typically constructed from a relatively uniform material. Load patches or doublers may be applied to specific load attachment points and end fittings. But, if used, fiber reinforcements typically take the form of either a fabric or a scrim laminated to the entire gore material or individual load tapes that run along the gore seams connecting the top and bottom end fittings. In either case, the most severe localized load determines the areal density of the gore material. Providing an adequate safety factor for this localized load means that the gore is considerably heavier than is necessary elsewhere.

Moreover, this traditional approach to inflatable design creates several problems for cost effective high performance applications. First, the existing method of reinforcement adds unnecessary weight while only addressing the worst case loading condition; this limits the payload that can be carried. Second, the production of seams, in order to manufacture the inflatable's envelope, creates stress concentrations in the envelope structure. Third, there are multiple load configurations that a system could see during deployment, inflation or flight, but current designs only deal with one well, leaving inefficient solutions for the others. Finally, the packing volume is excessive, since structures are currently created in their final three dimensional shape and then compressed for transit.

Just such a solution to the problems noted above and more, are made possible by our invention disclosed below.

### SUMMARY

An illustrative summary of the invention, with particular reference to the detailed embodiment described below, includes an apparatus and method for making high performance inflatables and deployables using three dimensionally reinforced (3DR) membranes. A 3DR process preferably takes plural substantially flat gore segments, each segment made of plural membranes and reinforcing fibers, and joins adjacent gores so the seams on opposite sides are offset. Single ply seam tape may be used. When all gores are joined, a three dimensional deployable or inflatable (e.g., balloon) structure with a minimized seam is produced. Further, localized fiber reinforcement is preferably used, with different characteristics (e.g., moduli, tension) depending on the desired placement in the gore, allowing the substantially flat gores, when joined and loaded, to strain to the desired three dimensional shape. In doing so, the required number of gores and seams may be reduced, while using materials with significantly lower areal densities. The 3DR process thus allows one to make locally reinforced materials that optimize strength to weight ratios; permits single ply width seam tapes; permits multi-phase optimized envelope shapes, designed to efficiently handle multiple loading conditions (storage, deployment, inflation, and multiple flight configurations); and provides increased design flexibility for a wide range of shapes and characteristics impractical or unavailable under prior techniques.

### BRIEF DESCRIPTION OF THE DRAWINGS

Our invention may be more readily appreciated from the following detailed description, when read in conjunction with the accompanying drawings, in which:

FIG. 1 illustrates a bi-taped seam such as that used in prior art techniques for joining segments of inflatables and deployables, with FIG. 1A showing a top view and FIG. 1B showing a cross-sectional view along the line A-A′.

FIG. 2 illustrates an offset-gore seam according to a first embodiment of the invention, with FIG. 1A showing a top view and FIG. 2B showing a cross-sectional view along the line A-A′.

FIGS. 3 through 7 illustrate steps in a process for the manufacture of a gore according to the first embodiment of the invention, where FIGS. 3A, 4A, 5A, 6A and 7 illustrate top views of a gore in progressive stages of manufacture, and FIGS. 3B, 4B, 5B and 6B show cross-sectional views along the line A-A′ for the respective top views;

FIG. 8 is a perspective view of a prior art inflatable; and

FIG. 9 is a perspective view of an inflatable with plural gores made according to the process of FIGS. 3 through 7.

### DETAILED DESCRIPTION

A more adaptable, low cost, and lighter weight deployable system is now possible through our invention, a presently preferred embodiment of which is the three dimensionally reinforced membrane (3DR) process and apparatus described below. By “deployable” we mean any one of the class of apparatuses using pressure-filled (e.g., inflatables like balloons) or pressure-displaced membranes (e.g., solar sails) to affect the location of a load (e.g., instruments) attached to the membrane structure.

There are two basic phases for production of 3DR deployables: membrane production, and sealing/joining. The membrane production process encompasses the design, placement, and laminating or curing (as required) of fibers and film. Different adhesives and adhesive types are accommodated with different dispensing systems. The seaming/joining process can be performed in two or three dimensions depending on the requirements of the finished shape or the joint construction. The sealing heat and pressure sources used depend on the desired seam configuration. A conventional near-IR (infrared) heater may be used in conjunction with vacuum bagging, supplemented by other existing sealing means such as a hot wheel sealer or manual heat sealer.

A 3DR deployable can be made either by special molds or a mold-less process. In the mold-less process, plural substantially flat gores are formed with top (outer) and bottom (inner) membranes joined via fibers, with edges of the top and bottom membranes offset from each other. When joining gores, the seams formed by adjacent outer membrane edges are offset from the seams formed by the adjacent inner membranes, preferably with one or more fibers being positioned between the offset seams. In a three-dimensionally molded process, adjacent gores membranes can be formed and seamed using an uninterrupted group of fibers common to each of the adjacent gores. In either case, the characteristics can be varied for different fibers used in the gores to achieve varying characteristics for the deployables.

Because significantly increased payloads for smaller size/areal density inflatables for high-altitude terrestrial applications, the 3DR inflatables now make possible a variety atmospheric in-situ (i.e., near-stationary in very high altitudes (15, 20 or more miles) with low atmosphere/low winds), long duration investigations for terrestrial atmospheric and climate studies, commercial applications like wireless communications and remote sensing, and military uses.

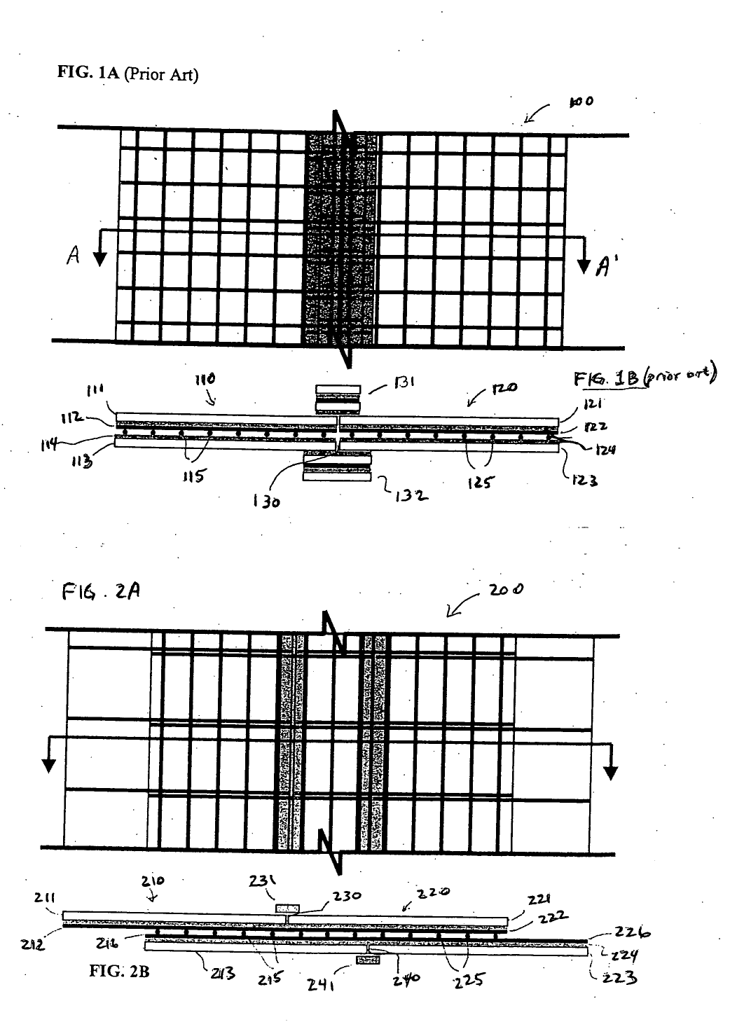

To help understand the 3DR system, FIG. 1 illustrates a bi-taped seam approach such as might be found in conventional high-altitude balloon construction. In this prior art approach, the balloon 100 is made up of plural gores 110, 120, each gore having outer 111, 121 and inner 113, 123 membranes, respectively, coated with adhesive 124, and latitudinal 112, 122, and longitudinal 115, 125 fibers. The inner and outer membranes form a common edge 130 in both gores. When joined, this edge is particularly susceptible to strains and early failure, so outer and inner tapes 131, 132 are joined (glued) along the length of the common edge to form seam 130. While seams of this type can be made sufficiently strong to successfully join the gores, they have all the attendant shortcomings noted above in connection with prior art deployables. These shortcomings are particularly limiting in high-altitude deployables (i.e., deployables designed to carry loads at heights greater than 10 km in the atmosphere or in space) like airships or superpressure balloons where the more limiting structure and payload weights limit the overall utility of the deployable.

By contrast, FIG. 2 shows two gores joined using the offset gore structure according to a presently preferred embodiment of the 3DR system. In this approach, the deployable 200 is similarly made up of plural gores 210, 220, each gore having outer 211, 221 and inner 213, 223 membranes, respectively, and latitudinal 212, 216, 222, 226 and longitudinal 215, 225 fibers. However, the outer membranes form a common edge 230 which is offset from the common edge 240 formed by inner membranes 213, 223. This process provides a near-seamless joint without the requirement for additional reinforcement.

By near-seamless, we mean a joint having a seam tape which seals adjacent membrane edges, such that the tape has a depth substantially (e.g., 20%, 50%, or even 75%) less than the depth of the gore (i.e., between the gore's inner and outer surfaces). In 3DR systems where the entire fiber is coated (e.g., see adhesive 224 on fiber 226), and one or more fibers join the membranes between each offset joint, a seam tape could be entirely dispensed with since the fiber(s) form a sealed lamination between offset seams. Nonetheless, one may still want to use the seam tapes to provide a back-up gas barrier, at least for one side of the inflatable. In systems where the fibers are only spot-welded e.g. where fibers overlap, the welds still provide the major load-bearing features but the seam tapes are preferred (over alternatives like continuous sealant joining the edges with each other and/or the opposite membrane) for forming the seal barrier.

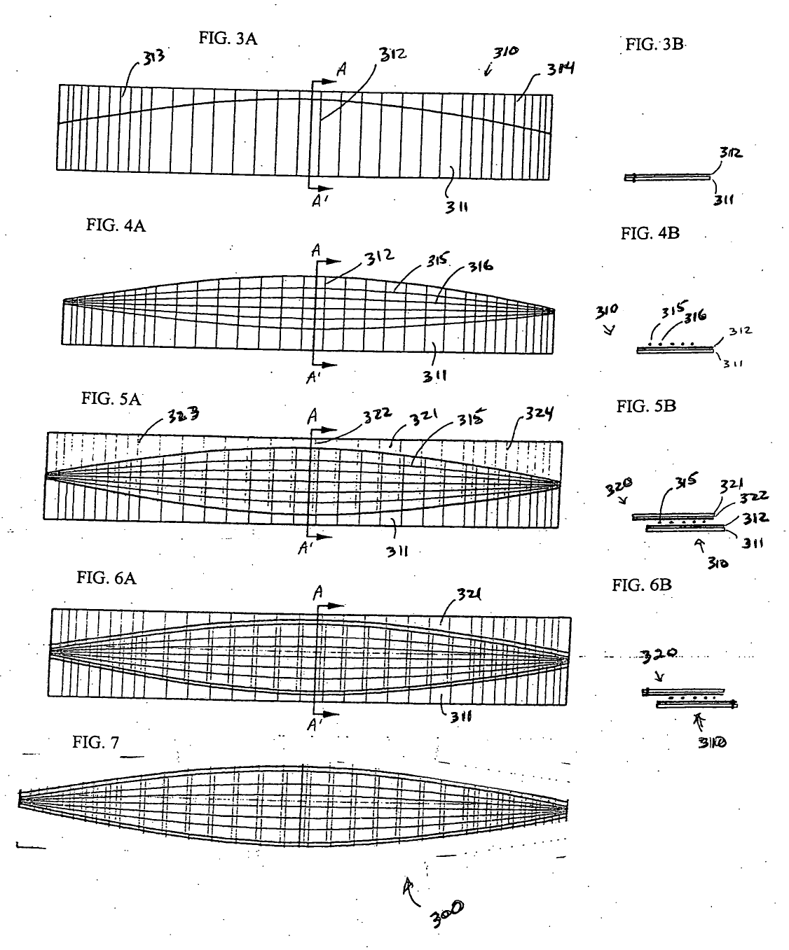

A “mold-less” process for making 3DR gores may be advantageously used in scaling up to extremely large structures, and is specially suited for high-altitude inflatables. In this process, each gore is made substantially flat, such as illustrated by FIGS. 3 through 7. Starting with FIG. 3A, a first sheet of membrane material 311 is laid out on a forming surface (in this case a flat surface), and fibers in a first orientation (e.g., latitudinal fibers 312-314) are positioned on the membrane. The fibers can be placed uniformly, but for many inflatables a non-uniform spacing may be preferred to achieve optimal load-bearing characteristics. For convenience, the resulting structure can be referred to as the inner panel 310 (i.e., where this panel is designed to be on the inside of the inflatable in the final assembly). As a practical matter, because the membranes for almost all inflatables will be narrow, the inner and outer panels will be the same size, just offset. Alternatively, one panel could be designed to overlap both edges of the other (the panels assembled with the overlapping panel alternating as inner then outer), or an inner panel could be designed as a different size (e.g., slightly smaller) than the outer panel. In the case of deployables that are not inflatables (e.g., solar sails), adjacent panels may vary significantly, depending on the final shape desired for the deployable. The panel is cut using any suitable cutting method to the specified curvature required by the design.

In FIG. 4, longitudinal fibers 315, 316 are laid on top of the inner panel in a desired orientation (preferably in arcs defined by common end points at (or beyond) the two ends of the panel 310 for inflatables). Next, in FIGS. 5 and 6, latitudinal fibers 322-325 of outer panel 320 are laid on top of inner panel 311/longitudinal fibers 315, 316, and outer membrane 321 is laid on top of the latitudinal fibers 322-324. The latitudinal fibers may be in any desirable orientation, but may be conveniently laid in complimentary spacing with respect to inner and outer panel fibers, so as to minimize the number of fibers required. The fibers and membranes are joined to each other by local bond, whether by application of an adhesive or (if permitted by the fiber properties) by welding (e.g., hot wheel) or other bonding (e.g., pressure sensitive) technique. In order to minimize the adhesive weight, spot welding may be done so that adhesive is only applied at fiber intersections (selected ones, or all), such that the intersections are joined to each other and the two membranes. Alternatively, the length of the fibers can be coated with adhesive such that the membranes and other fibers adhere to each fiber along its length.

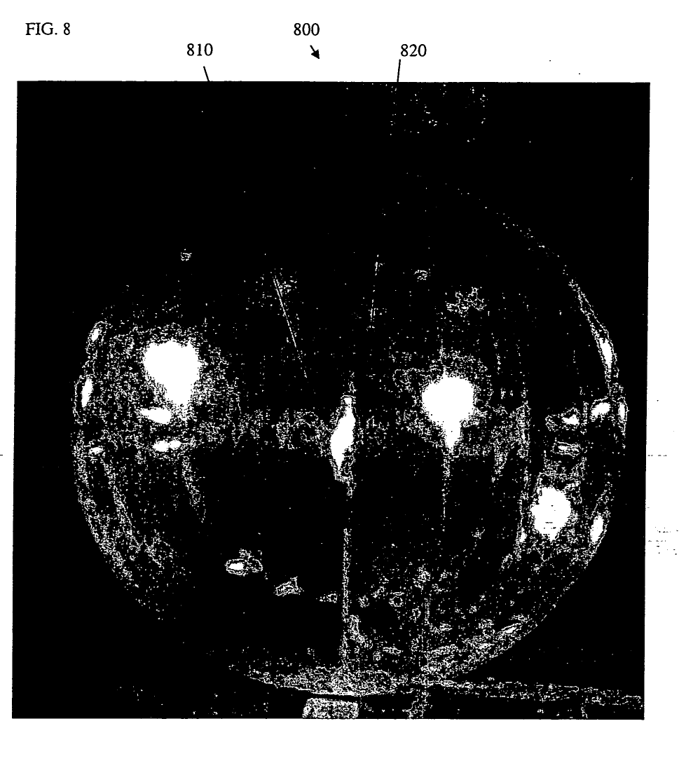

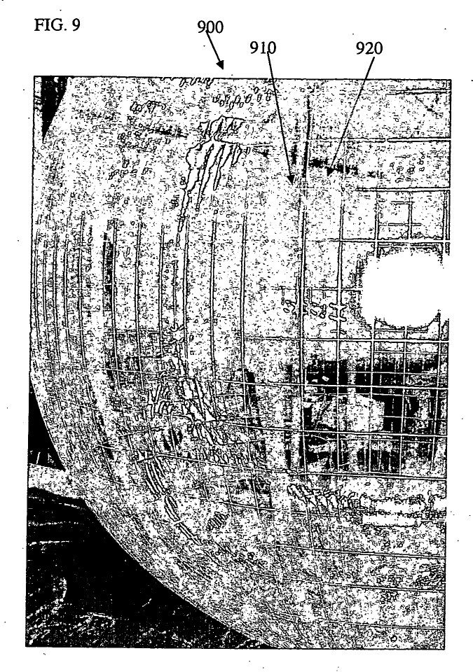

Finally, in FIG. 7, any suitable cutting method is used to trim excess membrane from the inner and outer panels. For most inflatables, most top membranes will be pre-trimmed (e.g., to the same shape shown in FIG. 4A for membrane 311) before being placed on the fibers. Both panels of the gore (see FIG. 6A) are then trimmed to leave opposite extending edges on both sides of central gore structure (defined by the portion two-membrane wide), with one offset edge part of the inner panel and the other offset edge part of the outer panel. In this manner, an alternating inner/outer panel extension/offset structure is produced, allowing complimentary extending portions from adjacent gores (e.g., 810, 820) to be joined to form a continuous structure (e.g., the ellipsoidal balloon 800 shown in FIG. 8). This process can also be done with pre-cut outer and inner films using the previously defined sequence with attention paid to the exact placement of each film layer.

The complimentary extending portions are joined in similar manner as opposite membranes of the same gore (i.e., spot welding, adhesive along the length of fibers, adhesive along the extending edge, adhesive on the seam tape, etc.) Depending on the structure geometry, the final or closing joint is made with the same technique (i.e. offset gore joint). The joints are made on simple curve, compound curvature, or flat vacuum backing fixtures. These fixtures may be designed so they are readily removed from the hole at the apex or nadir of the final inflatable. The holes may then be sealed with traditional techniques (e.g., balloon doubler techniques), although the doubler materials are preferably pre-fabricated on the 3DR gantry to again take advantage of the ability to place fibers where the load transition stress risers will be, in order to minimize localized stress and to create a gradient of stress into/out of the entire structure.

While it is possible to lay fibers in any orientation suitable to achieve the particular load and structural characteristics desired, in a typical inflatable (balloon) the fibers will be criss-crossed in a longitudinal and latitudinal formation, like that shown in FIGS. 4-8.

By “fibers” we mean any load-bearing filament, yarn, string or the like, whether from plants, metals or man-made materials, as suitable for the particular environment(s) and uses for which the deployable is designed. The actual membrane materials, fibers and adhesives used are a matter of design choice, that will vary depending on the nature of the deployable desired. For high-altitude inflatables, some of the materials that may be suitable as membrane and tape materials include a PET (Polyethylene Terephthalate) film (Dupont Mylar A & C, generic type A) and PVF (polyvinyl fluoride) films.

Examples of suitable fibers include Twaron (generic Kevlar), Spectra (UHMWPE-ultra-high molecular weight polyethylene), Zylon (PBO-Poly(p-phenylene-2,6-benzobisaxazole)), and Vectran (polyester-polyarylate) fibers. These appear to offer significantly better physical performance over aramids (while these may have other property concerns, when used with thin films, the fiber strength is the dominating factor combined with the specific trajectory paths used). Examples of suitable adhesives include PET, silicone & polyurethane adhesives.

In some applications, it may be preferable to use three dimensional molding to achieve the desired gore shape. One such technique for three dimensional molding is taught in U.S. Pat. No. 5,097,784 to Baudet. Here, a continuous, adjustable mold (up to 50 meters) is used for placing appropriately shaped load bearing yams between one or more inner/outer panels, to form a fixed shape sail. The inner layer of yarns are continuous from one edge of the sail to another (e.g., converging at one of the three corners), to better carry the majority of the wind load on the final sail. In the process of laying the yams, an adjustable three dimensional mold is used to hold the panel(s) in the desired shape, and a processor controlled gantry is disclosed for laying each continuous yam in the desired shape. By appropriate algorithmic control (which a skilled artisan could readily adapt for different geometries and lay characteristics, as desired), a variety of different patterns can be laid with the yarn.

The technique described in the Baudet patent is not directly applicable to the fabrication of space/high-altitude deployables, since it discloses technology aimed at sea level sailing (e.g., adhesives with a limited range of temperatures, limited geometries (no full or even hemi-ellipsoidal mold/structure), size capacity appropriate only for sailing boats, and no adequate means for scaling up processes and functionality for integrating large-scale inflatable assemblies. Nonetheless, this three dimensional technique may be usefully applied in three dimensional molding of gore segments for high-altitude deployables, with appropriate modifications. In such a case, it would not be a single, triangular wind sail that is formed, but one or more gores (or the joinder of plural gores) formed by means of varying three dimensional molds. Instead of sail yarns, lighter and variable fibers could be used. As noted above, only fiber coating or spot welding is needed to join the membranes and fibers—unlike the Baudet patent, which teaches applying adhesive to the entire panel to form a continuous laminate. But, fibers may be similarly laid for a given gore, by use of a gantry assembly or plotter to position the fiber as it is rolled onto the lower membrane (already on the mold).

When using a mold and fibers extending through plural gores, it is also possible to implement single membrane gores. In this case there is no offset, and tapes are required to form a gas seal, but the cross-gore load is still substantially borne by the inter-gore fibers.

Additionally, a 3DR deployable can be designed so each gore strains under load into the desired three-dimensional shape. This is accomplished by the choice of membrane, and reinforcing the membrane using specific fiber characteristics (e.g., varying moduli, tension, etc.) and geometries (trajectory shape and spacing). In controlling localized fiber reinforcement, the gore's properties can be varied spatially such that the gore will strain into a predetermined three-dimensional shape when placed under load. Thus, the structures can be designed to efficiently handle dramatically different loading conditions. In this way a 3DR deployable will provide significantly better performance than conventional techniques, where a significantly higher areal density material is required to provide adequate safety margins for a worst case condition (e.g., deployment) which is not the same as the condition for which the shape has been optimized (e.g., operation at a first altitude). Because the characteristics can be modeled beforehand, and automated control applied to vary placement and selection of individual fibers, a vast array of different shapes and characteristics are now possible across different operational conditions. For example, by using flat gores an optimal packing is possible, while decreasing latitudinal fiber moduli allows for a more gradual increase of the structure size during deployment, with the final (largest/widest) structure only following full deployment. Virtually any shape can be achieved, with greater fidelity and fewer gores than any prior art technique.

Further, in 3DR , the length, tension, and modulus of the fibers used in construction control the shape of the inflated envelope. Thus, the film need only serve as a low permeability membrane (by low permeability membrane, we mean a membrane that will take shape and strain, applying force against a load, in response to a gas, solar particles or the like; it need not be impermeable, although the lower the permeability the better the efficiency). This, combined with the offset gore joint, minimizes the physical mass of the system at joints, giving the system a near-seamless appearance. This also allows the film to be produced and packed as a substantially lay flat component. This flat initial shape with minimal voids results in a smaller packing volume for transit. Upon inflation, the system deforms to the 3-D shape dictated by the fiber structure.

Case Study 1. In a first space/planetary deployable design scenario, 3DR was considered in comparison to a Mars MABVAP (NASA-JPL's Mars Aerobot Validation Program) style mission. Some of the more significant environmental design conditions taken into account include a wide temperature range (55° C. to −128° C., for tensile property and permeability testing), extended duration as a packed balloon system (for months), and float at expected superpressure levels. A MABVAP base design typically consists of a 12.2μ-12.7μ polyester terepthalate (PET) film constructed with heat activated bi-taped seams of 12.7μ PET tape with 12.7μ of polyester adhesive. For this example the system design consists of a 10 m ø sphere with a float payload of 1.5 Kg, and a deployment payload of 20 Kg. Typical design areal density, weight and size is shown in the first column of Table 1.

The potential 3DR improvements for the planetary case are illustrated by column 2 of Table 1, using a PET film and aramid fibers. As is shown, initial testing indicates significantly smaller size, weight, density, and construction elements (hence cost) are required to achieve the same payload target as a conventional inflatable. Ultra-thin inflatables are also possible, with film thicknesses less than 3μ and two-sided laminate gore thicknesses less than 10μ.

TABLE 1
Comparison of Balloon Properties

| Property | Baseline Design | 3DR Design |
|---|---|---|
| Number of gores | 16 | 16 |
| Balloon Diameter, (m) | 10 | 7 |
| Balloon Volume (m³) | 524 | 186 |
| Float Pressure Alt. (mb) | 12.3 | 12.3 |
| Wt. of gore film (g) | 5,334 | 2,761 |
| Wt. of seams/fibers (g) | 1,347 | 50.72 |
| Net Wt. fittings (g) | 3.85 | 3.85 |
| Total weight (g) | 6,684.9 | 2,816 |
| Areal Density, (g/m²) | 21.23 | 8.95 |
| Film Thickness (μ) | 12.2 | 6.3 |

Case Study 2. A second target mission considered terrestrial applications based on the NOAA GAINS (Global Atmosphere-ocean IN-situ observing System) platform. The base balloon design for GAINS is a 147 gr/m2 Spectra fabric external shell with two 25.4μ polyurethane bladders inside. The associated valves and fittings are typical high altitude scientific balloon components. Inside the inner bladder is the lifting gas, while between the inner and outer bladders is the additional air ballast required to adjust the desired float density. The significant mission conditions include: extended duration radiation effects at float, temperature range, and creep. The one-year duration of the GAINS mission at 18 km float altitude exposes the 3DR structure to a significant dose of ultra-violet radiation. Using accelerated aging test equipment; 3DR laminates were tested for various durations up to the one-year maximum duration of the mission. The temperature range for this mission is +21° to −80° C.

In the GAINS terrestrial study, the films evaluated were thicker than those used for planetary MABVAP work, and also included several different types of base materials. Film thicknesses from 25.4μ to 88.9μ were considered. The films included polyvinyl fluoride (PVF), PET, and some specialty packaging films. In the end, significant areal density reductions were achieved, ranging from 28 to 36% compared to the base design. To expedite design considerations, automated tools should be used. For example, a FEA (finite element analysis) modeling design set of algorithms, and software tools may be advantageous when considering specific design variations. Results from FEA model runs have indicated that the use of different fibers and/or different moduli within a particular trajectory scheme could offer advantages. Used in conjunction with trajectory schemes that provide more uniform loading of the balloon during the various load conditions, different moduli could also have a positive impact on the areal density.

Those skilled in the art of geometric modeling of mechanical properties can design a variety of different tools without undue experimentation, tailored to specific mission goals, to determine satisfactory and optimal deployable design alternatives. Similarly, a skilled artisan could readily design appropriate control software for multi-axis (3, 6 or more, if desired) robotic gantry control to achieve predetermined, accurate placement of fibers on the membranes (whether flat or shaped), as well as particular fixtures for sealing (depending on the type, e.g., whether adhesive is continuously deposited when laying fibers, applied to detected fiber intersections, etc.), vacuum bagging, heating/laminating, lay-up and lamination tables, and the like, with variations dependent on the design objectives.

Production rates and quality may be effected by factors such as proper storage/pre-conditioning of selected materials, vacuum achieved prior to lamination, use of release films, and time/temperature/dwell differences in gore lamination and sealing. Typical balloon processing concerns may include cleanliness, station marks and alignment, static control, and film tension (removal of air and wrinkles). Minimum ambient and tooling temperatures, and maximum water vapor levels, may need to be determined and maintained for quality gore/seal production. Tensile tests may be a good indicator of lamination and seal quality, while testing on the permeance and gas transmission rates (GTR) at room temperature may correlate well with service temperature (potentially facilitating testing of material lots for consistency).

Prior approaches produced structures that had stress risers at the apex of the structure. With 3DR technology it is possible to eliminate most stress risers and provide a gradient dispersion of force across apex areas. Likewise, seam fiber transition was disjointed, not smooth, resulting in stress that could not transition across the seam and early failures. 3DR offset gore joints now permit the alignment of seam/joint fibers to facilitate stress transfer across the discontinuity of a joint, while reducing the mass in the seam. Testing has shown that the offset gore joint will produce a seam that is as strong as the parent material and as strong or stronger than a bi-tape seam.

When fabricating a gore, in the case where continuous adhesive is used on the fibers, some of the useful fabrication practices include: (i) condition (dry) the fibers, for selected ones at least 48 hours minimum; (ii) pre-cut one or both sides of the gore to the required curvature; (iii) pre-cut two pieces of release film with same curvature as gore edge and of a width appropriate for the seam width. (i.e., for a 1″ wide seam cut a 2″ wide release strip); (iv) place a base vacuum bag layer on the 3DR table and tension it so there are no wrinkles; (v) place a lower film layer in proper position with respect to a 0,0 mark (X position); (vi) using clean (cotton) gloves remove all wrinkles from film and remove all trapped air pockets between base film and lower gore film; (vii) if fibers are not pre-coated, mix up an appropriate adhesive system and load the adhesive head and/or adhesive reservoir according to the pattern to be run; (viii) spool up fibers on a yarn head and turn on heater; if pre-coated fibers are used, preheat for 15-30 minutes depending on quantity of yarn and spools; (ix) run Zero and home routines on the gantry to establish a baseline position; correct as required to obtain a repeatable position within +/−0.5 mm, and select the fiber trajectory plot file and execute; (x) as fibers are placed, be sure end points are constrained during head rotation, and cut fiber after securing to minimize excessive fiber usage; (xi) observe the head and remove any excessive adhesive build up prior to it passing onto the film with the fiber (creating a gel spot); (xii) when fibers are placed, place top film on buildup in proper X-Y position; touch in the geometric center and press to the outer edges in ever increasing circular/elliptical motions with a cotton gloved hand or press down on short axis continuous line with a release covered roll, then roll to each end in one continuous motion while maintaining a slight tension of the film at the tip and keeping it slightly elevated with respect to the surface of the table; (xiii) if any air pockets are noted, they should be worked out (by gloved hand); (xiv) place an air breather and vacuum bag sealant tape around gore(s), providing sufficient airway for good vacuum; (xv) cover the entire setup with top vacuum release film, seal edges with brayer and eliminate all wrinkle gaps; (xvi) install vacuum connection fitting and gauge fitting; install vacuum gauge, connect the vacuum pump and start; pull down to around 24″ Hg minimum; (xvii) change yarn head for IR heater use (placed on the gantry); start the heater, warming up to operating temperature; (xviii) select an appropriate cure program and execute, monitoring surface temperature with a temperature sensor (record data midway through each pass; if insufficient temperature is reached to initiate, the cure pattern may be run again if using thermoplastic adhesive; if not, thermoplastic and kickoff temperature may not be continuous and the part will likely need to be scrapped); (xix) after the cure process, remove vacuum and fittings, release layer, and air breather material; (xx) lift the gore from the table, being careful to leave edge release strips intact; place the gore on an auxiliary flat surface between two layers of release film; place weight bags or the like around the perimeter to minimize exposure to moisture.

When fabricating a gore offset joint, particularly where the gore edges are compound surfaces using three-dimensional arch fixtures, some of the useful fabrication practices include: (i) select a first gore to be joined, removing the release edge strip; (ii) start a vacuum on the arch and close off the bypass valve completely; (iii) place the edge of film along a centerline to the arch; fibers should be on the up side away from arch surface; (iv) select a second gore to be joined, removing the release edge strip; (v) place the gore on arch, with the edge on a centerline with its edge fiber facing down toward the other gore's upward facing edge fibers; (vi) verify alignment of cross over fibers; correct any fibers that are not within a predetermined position (e.g., 1 cm) of each opposing fibers in the pattern of the other gore; (vii) adjust a bypass valve as required to maintain a predetermined (e.g., 24″ water) vacuum; (viii) cover the joint with a release film that is long enough to reach the lower ends of the arch (in order to be held with the vacuum); (ix) install the Joint IR heater head on the gantry; (x) verify the heat shield is available for start and end of pass(es); (xi) select a suitable cure program and execute; (xii) use a heat shield as needed to protect the joint from overheating at start and end of the pass; (xiii) open a bypass valve, remove the release film; (xiv) rotate the sealed gores into a cradle under the arch; position a next edge as in step (i) above; (xv) select a next gore and repeat steps (i) through (xiv) until the complete deployable is formed (and in the case of inflatables, attach load/deployment system and seal the ends).

Of course, one skilled in the art will appreciate how a variety of alternatives are possible for the individual elements, and their arrangement, described above, while still falling within the spirit of our invention. Further, while the above describes several embodiments of the invention used primarily in connection with inflatables, those skilled in the art will appreciate that there are a number of alternatives, based on deployable systems design choices, and choice of materials, and the like that still fall within the spirit of our invention. Thus, it is to be understood that the invention is not limited to the embodiments described above, and that in light of the present disclosure, various other embodiments should be apparent to persons skilled in the art. Accordingly, it is intended that the invention not be limited to the specific illustrative embodiments.

We claim:

1. A deployable system, comprising:
plural segments, each segment comprising plural membranes and plural reinforcing fibers attached to the membranes, the segment being formed so a first edge of a first membrane is offset from the adjacent first edge of a second membrane;
wherein each segment is sealingly joined and at least one tape joining adjacent membranes of adjacent segments, so as to form a three-dimensional fiber-reinforced load-bearing composite membrane structure; and
a load operably coupled to the composite membrane structure.

2. The system of claim 1, wherein each segment is a gore and the deployable system is an inflatable.

3. The system of claim 1, wherein the plural reinforcing fibers have non-uniform, predetermined characteristics.

4. The system of claim 3, wherein the predetermined characteristics are one of the group of differing moduli and tension, whereby predetermined characteristics of the gore will vary as deployment conditions change.

5. The system of claim 4, wherein the gore characteristics comprise gore shape, and the deployment conditions comprise compact storage, deploying, and full loaded configurations.

6. The system of claim 1, wherein the fibers are attached to the gas membranes by one of the group of adhesive coating the membrane, adhesive coating the fibers, and adhesive applied to intersections of fibers.

7. The system of claim 1, wherein:
the fibers consist of at least one from the group of a filament, yam, and string made with Twaron, Kevlar, Spectra, Zylon, Vectran, aramids, and celulosics;
the membrane and tapes consist of at least one of the group of a single layer film, a multilayer film, a PET film, Mylar, PVF; Heptax, Dartek, film; and
the adhesive consists of at least one from the group of a PET, acrylics, cyanoacrylates, silicone and polyurethane adhesive.

8. The system of claim 1, wherein each adjacent membrane along the plural offset seams formed by two adjacent segments is sealed by a near-seamless tape member.

9. A load-bearing membrane apparatus operable for positioning a deployable system, comprising:
plural segments, each segment comprising a membrane and plural reinforcing fibers attached to the membrane, the plural reinforcing fibers have non-uniform, predetermined characteristics;
wherein each segment is sealingly joined and a tape member joining adjacent membranes of adjacent segments, so as to form a three-dimensional fiber-reinforced load-bearing composite membrane structure configured to receive a load.

10. The apparatus of claim 9, wherein the predetermined characteristics are one of the group of differing moduli and tension, whereby predetermined characteristics of the gore will vary as deployment conditions change.

11. The apparatus of claim 10, wherein the gore characteristics comprise gore shape, and the deployment conditions comprise compact storage, deploying, and full loaded configurations.

12. The apparatus of claim 9, wherein the fibers of each segment are attached to the membrane by one of the group of adhesive coating the membrane, adhesive coating the fibers, adhesive applied to intersections of fibers, and direct bonding to the membrane surfaces.

13. The apparatus of claim 12, wherein each segment is a gore with plural membranes, an first edge of a first membrane being offset from the adjacent first edge of a second membrane.

14. The apparatus of claim 13, wherein each segment is a substantially flat gore and the deployable system is a three dimensional inflatable.

15. The apparatus of claim 14, wherein each adjacent membrane along the plural offset seams formed by two adjacent segments is sealed by a near-seamless tape member.

16. A method for making a load-bearing membrane apparatus operable for positioning a deployable system, comprising:
forming plural segments by, for each segment, attaching plural reinforcing fibers to a membrane, the plural reinforcing fibers have non-uniform, predetermined characteristics;
sealingly joining the plural segments by positioning each segment adjacent at least one other segment and joining said segment and the at least one other segment with a tape member, so as to form a three-dimensional fiber-reinforced load-bearing composite membrane structure configured to receive a load.

17. The method of claim 16, wherein the step of sealingly joining further comprises attaching the fibers of each segment to the membrane by one of the group of adhesive coating the membrane, adhesive coating the fibers, adhesive applied to intersections of fibers, and direct bonding to the membrane surfaces.

18. The method of claim 17, wherein the step of forming each segment further comprises first offsetting a first membrane from an adjacent first edge of a second membrane, whereby when the plural reinforcing fibers are attached the fibers and first and second membrane form a gore with plural membranes.
